(19) United States
(12) Patent Application Publication
(10) Pub. No.: US 2012/0221373 A1
(43) Pub. Date: Aug. 30, 2012

(54) Estimating Business Service Responsiveness

(76) Inventors: Manish Marwah, Palo Alto, CA (US); Brian J. Watson, Jacksonville, FL (US); Daniel Juergen Gmach, Palo Alto, CA (US); Yuan Chen, Sunnyvale, CA (US); Zhikui Wang, Fremont, CA (US); Cullen E. Bash, Los Gatos, CA (US); Jerome Rolia, Kanata (CA); Mustazirul Islam, Rocklin, CA (US); SM Prakash Shiva, Bangalore (IN)

(21) Appl. No.: 13/036,466

(22) Filed: Feb. 28, 2011

(51) Int. Cl. G06Q 10/00

(52) U.S. Cl. 705/7.27

(57) ABSTRACT

An embodiment includes gathering input data including observed utilizations of allocations and business service response times. The input data is partitioned into a plurality of data sets that include at least one training data set and at least one test data set. A model is generated that predicts responsiveness using the at least one training data set. The model is evaluated using the at least one test data set, and a business service response time distribution is predicted using the model. An embodiment may use a trace-based capacity planning methodology to estimate the impact of planning alternatives on business service responsiveness.

### BACKGROUND

Queueing models are used to mathematically predict response times of business services in capacity planning scenarios, which are used to understand the attributes of service as well as meet any service level agreement (SLA) performance targets. In general, queueing models require cumbersome predictive modeling validation steps and only predict mean response time values. Additionally, queuing models make simplifying assumptions which may not hold in actual practice. Further, many queueing models may be required for compatibility with trace-based planning methods that consider time varying system behavior.

In order to eliminate the predictive modeling validation steps, empirical models may be used to mathematically predict response times of business services in capacity planning scenarios. However, most empirical models use average performance metrics, such as mean response time, for capacity planning scenarios. Average performance guarantees typically are not sufficient to express SLA requirements for many applications, particularly interactive applications. SLAs often reference percentile performance guarantees, such that end users receive a percentage of response times below an agreed upon threshold. Thus, empirical models using average performance guarantees are not effective in capacity planning scenarios because they may not satisfy typical SLA requirements.

### BRIEF DESCRIPTION OF THE DRAWINGS

Certain exemplary embodiments are described in the following detailed description and in reference to the drawings, in which:

FIG. 1 is a process flow diagram showing a computer-executed method for estimating business service responsiveness according to an embodiment;

FIG. 2 is a graph showing a comparison of modeled and measured cumulative response time distributions;

FIG. 3 is a block diagram of a system that may estimate business service responsiveness according to an embodiment; and

FIG. 4 is a block diagram showing a non-transitory, computer-readable medium that stores code for estimating business service responsiveness.

### DETAILED DESCRIPTION

Embodiments of the invention provide an estimate of business service responsiveness based on historical measures using empirical data. Additionally, embodiments of the present invention operate with minimal domain knowledge. Further, an embodiment of the present invention can use a trace-based capacity planning methodology to estimate the impact of planning alternatives on business service responsiveness. Planning alternatives may include utilizations of allocation to achieve certain response time objectives or predicting the impact of different consolidation scenarios on response times using a particular model. Predicting may include, but is not limited to, rendering the model or otherwise reporting the model data distribution.

The ability to accurately estimate resources required to service a particular workload while meeting performance targets, which may be specified in SLAs, helps to provide effective resource utilization. Accurate estimates of the resources required to service a particular workload may minimize servicing costs. Overestimating the resources required may result in an over-provisioned system with low utilization and idle resources. Conversely, underestimation of the resources needed may result in poor performance leading to possible violation of the SLA.

A quantile modeling approach to building a model that relates an application performance metric, such as response time, to resource utilization using historical traces of resource usage metrics, such as the CPU or memory accurately estimates the resources required to service a particular workload while meeting performance targets. Particularly, modeling the probability distribution of an application performance metric conditioned on one or more input variables that are measured or controlled, such as system resource utilization and allocation metrics, allows for a more accurate model. With a probabilistic model, the probability of satisfying a percentile performance requirement can be calculated given knowledge of the input variables during a particular time interval. The model may be referred to as a Utilization of Allocation to Response time (UA2R) model.

In an embodiment, a model that relates observed allocation usage (or utilizations of allocations) and business service response times is built. A model for the distribution of response time values is maintained for a business service, its workloads, and a range of values of utilization of allocations. The model is then used to provide insights to a capacity planner when selecting target utilization of allocation values. Additionally, the model can also be used by planning tools to report on the expected response time of a business service for some planning scenario.

Consider the use of the UA2R model for a virtual machine (VM) in the following three scenarios. First, suppose an allocation for a VM always stays the same and the VM never gets more or less than its allocation. If the future trace of utilization of allocations is the same as previous utilization of allocations, then the response time distribution may not change. Further, assume the demands and, as a result, utilizations increase by some percentage due to an expected or planned uniform increase in workload. In this scenario, the UA2R model predicts the impact on the response time distribution. Second, suppose that the allocation for a VM is to be changed. The utilizations then increase or decrease proportionally, and the UA2R model predicts the impact on the response time distribution. Third, suppose allocations are not enforced and that servers may be oversubscribed. For this scenario, the historical allocations change depending on contention for the shared server. Calibration of the UA2R model may use “effective” allocation as input. Effective allocation is the time varying capacity that a VM has access to as a result of the observed competition incurred for shared resources. The utilization is the utilization of the effective allocation and the response time is as observed. In this third scenario, the UA2R model may still track the relationship between response times and utilization of allocation.

A UA2R model tracks response time distribution. In particular, instead of modeling the mean value, quantiles of response time are modeled. Since SLAs typically specify performance guarantees in percentiles, such as a performance guarantee that some percentage (for example, ninety-five percent) of end users receive response times below an agreed upon threshold, percentiles may be a more useful metric to model than the mean values. These percentiles may be modeled through quantile regression. As with conventional regression analysis, quantile regression optimizes the parameters or coefficients for a specified functional form such that the function models a certain characteristic of the data. While conventional regression analysis minimizes the sum of squared residuals (or errors) to generate a model of the mean conditioned on a set of variables, an alternative may be to minimize the sum of absolute residuals to yield a model of the median, for example, the 0.5 quantile (50th percentile). Likewise, to obtain models for other quantiles, asymmetric weights may be applied to the absolute value of positive and negative residuals. For example, weighting positive residuals three times as much as negative residuals produces a model for the 0.75 quantile (75th percentile). This optimization problem can be solved using linear programming methods like Simplex.

A model quantile q of the response time as a function of utilization of allocation is mathematically described below:

RT_{q}=F(u) (1)

q=P(t<RT_{q}) (2)

In other words, the probability that the predicted response time is less than the modeled response time is q. Note that the utilization of allocation u can be a vector if the response time depends on utilization of multiple resources.

To fit the experimental data, three parametric functional forms may be evaluated: linear (3), exponential (4), and a combination of linear and exponential (5).

F(u)=a+b*u (3)

F(u)=exp(a+b*u) (4)

F(u)=a+b*u+exp(c+d*u) (5)

Variables a and b may be determined with training data during the model generation. If the relationship between utilization and response time is linear, then the linear equation (3) may be used for the model. Likewise, if the relationship between utilization and response time is exponential, then the exponential equation (4) may be used for the model. The combination of equations (5) is able to model both relationships, however, determining the values of a, b, c, and d may be more difficult. Also, note that test data may also be used to determine the parametric functional form selected. The relationship between utilization and response time does not need to be defined prior to selecting a functional form to use for the model. Further, several models with different functional forms may be trained, and the model that performs the best on the unseen test data may be selected.

The function used may take any form, however, these exemplary forms were chosen since response time versus utilization tends to show linear behavior at low utilizations and exponential at high utilizations. However, a non-linear model such as equation (5) requires solution of a more complex optimization problem to determine the coefficients, and in some cases it may be hard to reach convergence. Note that equation (4) is effectively a linear model if the data is transformed by taking logarithm of the response time.

Another performance metric, such as request throughput, could be modeled with one or more utilization values as input data. Additional metrics may include dropped or cancelled requests. These additional metrics are like response times because the relationship is expected to be non-linear. For some systems, throughput may also be non-linear with respect to utilizations, and as a result, throughput may also a reasonable metric. For example, SAP systems have demands per request that tend to decrease as utilization increases. Modeling throughput may show this non-linear relationship. Additionally, such a model may be used to efficiently provision for SLA request throughput targets, if any.

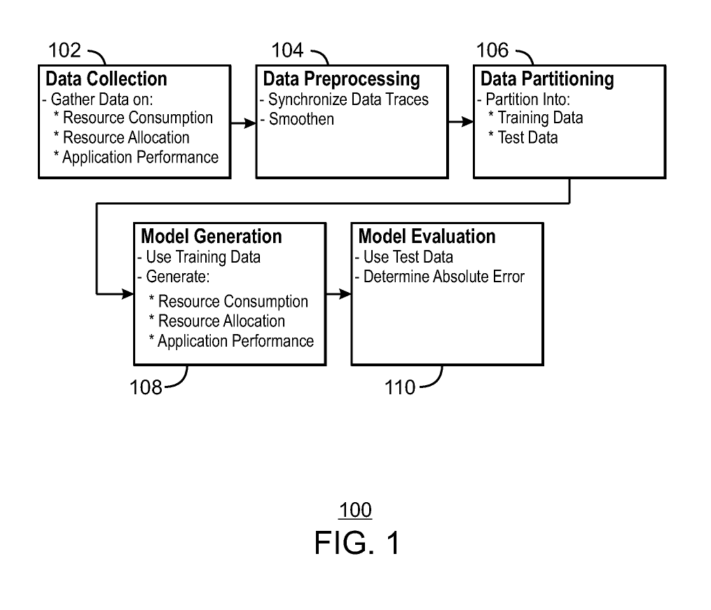

FIG. 1 is a process flow diagram showing a computer-executed method for estimating business service responsiveness based on historical measures according to an embodiment. At block 102, input data is gathered including observed utilizations of allocations and business service response times. This input data may also be time series data such as response time and utilization time data. Further, this input data may include resource consumption, resource allocation, or application performance. Additionally, one or more other resources, such as memory usage, network bandwidth, that may impact performance could be used as input data. At block 104, data preprocessing is performed. Data preprocessing may include the cleansing, smoothing and synchronization of the various input data.

At block 106, the input data is partitioned. Partitioning the input data may include splitting the input data into a training set and a test set. The training set is used for determining the parameters of the model, while the test set is used for evaluating the model's performance. At block 108, a model that predicts responsiveness is generated based on the training data. The model may be generated by fitting the training data set to a suitable parametric form and using quantile regression to build the model. The model generated may be based on include a linear model, an exponential model, and or a combination of linear and exponential models.

At block 110, the model is evaluated using the test set. Metrics such as absolute mean error are used for quantifying the performance of a model. Once the model is prepared, it can be used to support resource planning exercises, such as predicting a business service response time distribution. Additionally, a user of the model may relate the desired business service responsiveness to the service's historical utilization of its resource allocations. That information can then be used to establish a requirement for utilization of allocation that meets the desired response time goals. The requirement can be used for planning purposes in accordance with SLAs. Alternatively, a particular resource management plan may lead to a particular behavior for utilization of allocation. The model can then be used to transform the plan's utilization of allocations to a prediction for business service responsiveness.

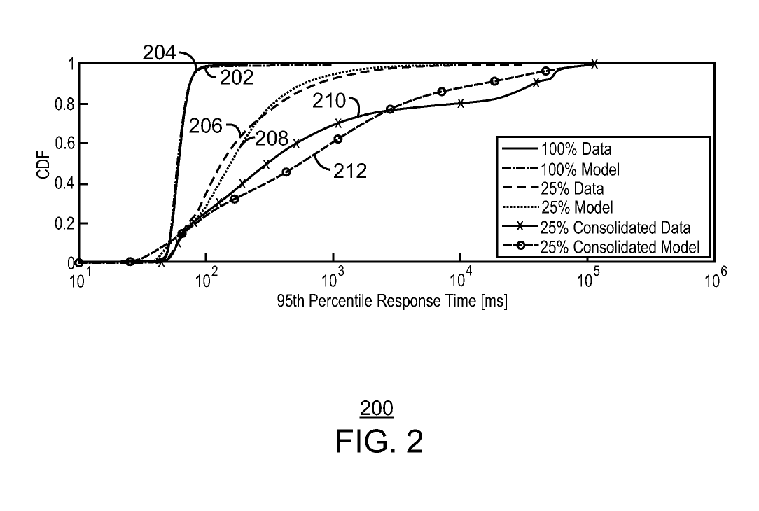

FIG. 2 is a graph 200 showing a comparison of modeled and measured cumulative response time distributions. The data represented by graph 200 is based on extensive experiments on a UA2R model to collect utilization and response time data using a virtualized test bed consisting of three physical servers. A modified 3-tier RUBiS e-commerce application and transaction traces adapted from a real application was used in the experiments. The RUBiS implementation consisted of a front-end Apache web server, a JBoss application server, and a MySQL database server. Utilization of the web, application, database VMs, and response time data were collected for allocations of 25%, 40%, 70% and 100% of the server's capacity. For the 25% allocation, models were generated for a consolidated case as well, where all the three VMs were co-located on a physical server. After pre-processing, a training data set (80% of total) was used to build a model for each the allocation test cases. All model errors are less than about 5%.

The 100% measured data case at 202 is virtually the same as the 100% modeled data case at 204. Likewise, the 25% measured data case at 206 is virtually the same as the 25% modeled data case at 208. However, the 25% consolidated measured data case at 210 is distinguishable from the 25% consolidated modeled data case at 212. Although the allocations in the consolidated measured data case 210 and consolidated modeled data case 212 are the same, their response time distribution differs due to contention. The consolidated measured data case 210 and consolidated modeled data case 212 are not identical, but the predicted behavior is sufficient for capacity planning.

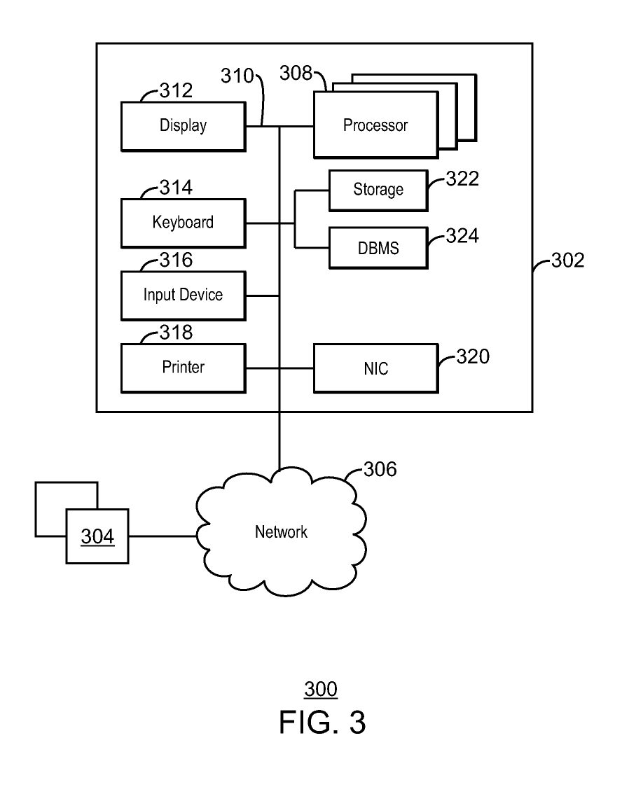

FIG. 3 is a block diagram of a system that may estimate business service responsiveness according to an embodiment. The system is generally referred to by the reference number 300. Those of ordinary skill in the art will appreciate that the functional blocks and devices shown in FIG. 3 may comprise hardware elements including circuitry, software elements including computer code stored on a tangible, a machine-readable medium, or a combination of both hardware and software elements. Additionally, the functional blocks and devices of the system 300 are but one example of functional blocks and devices that may be implemented in an embodiment. Those of ordinary skill in the art would readily be able to define specific functional blocks based on design considerations for a particular electronic device.

The system 300 may include a server 302, and one or more client computers 304, in communication over a network 306. As illustrated in FIG. 3, the server 302 may include one or more processors 308 which may be connected through a bus 310 to a display 312, a keyboard 314, one or more input devices 316, and an output device, such as a printer 318. The input devices 316 may include devices such as a mouse or touch screen. The processors 308 may include a single core, multiples cores, or a cluster of cores in a cloud computing architecture. The server 302 may also be connected through the bus 310 to a network interface card (NIC) 320. The NIC 320 may connect the server 302 to the network 306.

The network 306 may be a local area network (LAN), a wide area network (WAN), or another network configuration. The network 306 may include routers, switches, modems, or any other kind of interface device used for interconnection. The network 306 may connect to several client computers 304. Through the network 306, several client computers 304 may connect to the server 302. The client computers 304 may be similarly structured as the server 302.

The server 302 may have other units operatively coupled to the processor 308 through the bus 310. These units may include tangible, machine-readable storage media, such as storage 322. The storage 322 may include any combinations of hard drives, read-only memory (ROM), random access memory (RAM), RAM drives, flash drives, optical drives, cache memory, and the like. The storage 322 may include the software used in an embodiment of the present techniques. In an embodiment, the model generated may reside in storage 322. The database management system (DBMS) 324 may be used to store historical data according to an embodiment of the present techniques. Although the DBMS 324 is shown to reside on server 302, a person of ordinary skill in the art would appreciate that the DBMS 324 may reside on the server 302 or any of the client computers 304.

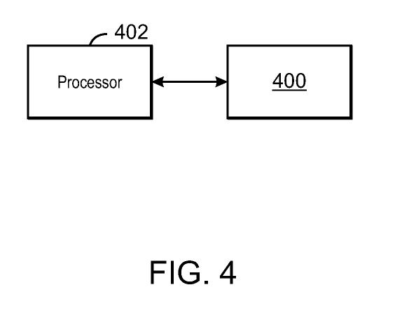

FIG. 4 is a block diagram showing a non-transitory, computer-readable medium that stores code for estimating business service responsiveness. The non-transitory, computer-readable medium is generally referred to by the reference number 400.

The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices.

Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, and flash memory devices.

A processor 402 generally retrieves and executes the computer-implemented instructions stored in the non-transitory, computer-readable medium 400 to estimating business service responsiveness. Input data may be gathered. The data may be partitioned into a plurality of data sets. A model is generated based on at least one data set, and the model is evaluated based on another data set. A business service response time may be predicted.

What is claimed is:

1. A computer system for estimating business service responsiveness, comprising:
a processor that is adapted to execute stored instructions; and
a memory device that stores instructions, the memory device comprising computer-executable code, that when executed by the processor, is adapted to:
gather input data including observed utilizations of allocations and business service response times;
partition the input data into a plurality of data sets that include at least one training data set and at least one test data set;
generate a model that predicts responsiveness using the at least one training data set;
evaluate the model using the at least one test data set; and
predict a business service response time distribution using the model.

2. The system recited in claim 1, wherein the input data gathered includes resource consumption, resource allocation, application performance, or data from one or more other resources.

3. The system recited in claim 1, wherein the input data is preprocessed by cleansing, synchronizing or smoothing data traces.

4. The system recited in claim 1, wherein the model is generated based on a linear model, an exponential model, or a combination of a linear model and an exponential model.

5. The system recited in claim 1, wherein the model is generated by fitting the at least one training data set to a suitable parametric form and using quantile regression to build the model.

6. The system recited in claim 1, wherein a performance metric is modeled based on one or more utilization values as input data, or absolute mean error is used to quantify the performance of the model.

7. The system recited in claim 1, wherein a trace-based capacity planning methodology is used to estimate the impact of planning alternatives on business service responsiveness.

8. A method for estimating business service responsiveness based on historical measures, comprising:
gathering input data including observed utilizations of allocations and business service response times;
partitioning the input data into a plurality of data sets that include at least one training data set and at least one test data set;
generating a model that predicts responsiveness using the at least one training data set;
evaluating the model using the at least one test data set; and
predicting a business service response time distribution using the model.

9. The method recited in claim 8, wherein the input data gathered includes resource consumption, resource allocation, application performance, or data from one or more other resources.

10. The method recited in claim 8, comprising preprocessing the input data by cleansing, synchronizing or smoothing data traces.

11. The method recited in claim 8, wherein the model is generated based on a linear model, an exponential model, or a combination of a linear model and an exponential model.

12. The method recited in claim 8, wherein the model is generated by fitting the at least one training data set to a suitable parametric form and using quantile regression to build the model.

13. The method recited in claim 8, wherein a performance metric is modeled based on one or more utilization values as input data, or absolute mean error is used to quantify the performance of the model.

14. The method recited in claim 8, wherein a trace-based capacity planning methodology is used to estimate the impact of planning alternatives on business service responsiveness.

15. A non-transitory, computer-readable medium, comprising code configured to direct a processor to:
gather input data including observed utilizations of allocations and business service response times;
partition the input data into a plurality of data sets that include at least one training data set and at least one test data set;
generate a model that predicts responsiveness using the at least one training data set;
evaluate the model using the at least one test data set; and
predict a business service response time distribution using the model.

16. The computer-readable medium recited in claim 15, wherein the input data gathered includes resource consumption, resource allocation, application performance, or data from one or more other resources.

17. The computer-readable medium recited in claim 15, comprising code configured to direct a processor to preprocess the input data by cleansing, synchronizing or smoothing data traces.

18. The computer-readable medium recited in claim 15, wherein the model is generated based on a linear model, an exponential model, a combination of a linear model and an exponential model, or the model is generated by fitting the at least one training data set to a suitable parametric form and using quantile regression to build the model.

19. The computer-readable medium recited in claim 15, wherein a trace-based capacity planning methodology is used to estimate the impact of planning alternatives on business service responsiveness.

20. The computer-readable medium recited in claim 15, wherein a performance metric is modeled based on one or more utilization values as input data, or absolute mean error is used to quantify the performance of the model.
